(19) United States
(12) Patent Application Publication
(10) Pub. No.: US 2005/0140473 A1
(43) Pub. Date: Jun. 30, 2005

(54) Microstrip cross-coupled bandpass filter with asymmetric frequency characteristic

(76) Inventors: Dong-Suk Jun, Daejeon-city (KR); Hong-Yeol Lee, Cheongju-city (KR); Sang-Seok Lee, Daejeon-city (KR); Kyoung-Suk Ko, Cheongju-city (KR); Dong-Young Kim, Daejeon-city (KR); Kyoung-Ik Cho, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/934,672

(22) Filed: Sep. 3, 2004

(30) Foreign Application Priority Data
Dec. 24, 2003 (KR) 10-2003-0096309

(51) Int. Cl. H01P 1/203

(52) U.S. Cl. 333/204

(57) ABSTRACT

A microstrip cross coupling bandpass filter includes an input port, an input resonator, an output port, and an output resonator. The input port and the input resonator are electric-coupled, and the output port and the output resonator are electric-coupled. A cross coupling gap corresponding to the distance between the input and output resonators forms magnetic coupling. The bandpass filter further includes a cross coupling line electric-coupled with the input and output ports. The cross coupling gap generates an attenuation pole on the high side of a passband. The attenuation frequency of the attenuation pole can be varied with the distance of the cross coupling gap. The cross coupling line generates an attenuation pole on the high and low sides of the passband.

### CROSS REFERENCE TO RELATED APPLICATION

This application claims priority to and the benefit of Korea Patent Application No. 2003-96309 filed on Dec. 24, 2003 in the Korean Intellectual Property Office, the entire content of which is incorporated herein by reference.

### BACKGROUND OF THE INVENTION

(a) Field of the Invention

The present invention relates to a bandpass filter, and more particularly, to a microstrip bandpass filter with an asymmetric frequency characteristic, which includes cross coupling and resonators.

(b) Description of the Related Art

Recently, a component in the form of a waveguide has been generally used as a bandpass filter in a millimeter-wave home network system. Although the waveguide component has low loss and high attenuation characteristics, its cost, size, and weight cannot satisfy the millimeter-wave home network's demand.

A conventional microstrip cross-coupled bandpass filter that includes resonators and has an asymmetric frequency characteristic is explained with reference to FIGS. 1, 2, 3, and 4. FIG. 1 shows a pattern of a bandpass filter including open-loop resonators. FIG. 1a shows a bandpass filter pattern having an attenuation pole on the high side of a passband, and FIG. 1b shows a bandpass filter pattern having an attenuation pole on the low side of the passband.

The bandpass filter 100 shown in FIG. 1 includes an input port 101, an output port 102, an input resonator 111, an upper resonator 112, and an output resonator 113. The bandpass filter 100 includes coupling 121 between the input port 101 and the input resonator 111, coupling 122 between the input resonator 111 and the upper resonator 112, coupling 123 between the upper resonator 112 and the output resonator 113, coupling 124 between the output port 102 and the output resonator 112, and coupling 131 between the input resonator 111 and the output resonator 112. However, the band pass filter pattern shown in FIG. 1a has no coupling between the input port 101 and the input resonator 111 and no coupling between the output port 102 and the output resonator 113 because the input port 101 and the output port 102 respectively come into contact with the input resonator 111 and the output resonator 113.

When a signal is input through the input terminal 101, the input signal is electric-coupled at coupling 121 to the input port 101 and the open-loop input resonator 111. The electric-coupled signal is electric-coupled at coupling 122 with the open-loop upper resonator 112 to be transmitted to the upper resonator 112. The transmitted signal is electric-coupled at coupling 123 to the open-loop output resonator 113 to be transferred from the upper resonator 112 to the open-loop output resonator 113. The signal transferred to the output resonator 113 selects a characteristic band to be output through electric coupling of the output port 102 and the open-loop output resonator 113.

In FIG. 1a, main coupling is electric coupling, and the open-loop input resonator 111 and the open-loop output resonator 113 are electric-coupled. Accordingly, an attenuation pole is formed on the high side of the passband, and the attenuation pole characteristic and frequency are controlled by cross coupling.

In FIG. 1b, main coupling is electric coupling, and the open-loop input resonator 111 and the open-loop output resonator 113 are magnetic-coupled. Thus, an attenuation pole exists on the low side of the passband. The bandpass filter of FIG. 1 is suitable for a mobile communication system because it has high selectivity channeling and low insertion loss. However, the bandpass filter has only a single attenuation pole and there is a restriction on its design caused by the value of the dielectric constant.

FIG. 2 shows a pattern of a bandpass filter including triangular patch resonators. FIG. 2a shows a bandpass filter pattern having an attenuation pole on the high side of a passband, and FIG. 2b shows a bandpass filter pattern having an attenuation pole on the low side of the passband.

The bandpass filter including the triangular patch resonators has a small size and forms an attenuation pole on each of the high and low sides of the passband.

In FIG. 2, the bandpass filter 200 includes an input port 201, an output port 202, an input resonator 211, an upper resonator 212, and an output resonator 213. The bandpass filter 200 further includes coupling 221 between the input port 201 and the input resonator 211, coupling 222 between the input resonator 211 and the upper resonator 212, coupling 223 between the upper resonator 212 and the output resonator 213, coupling 224 between the output port 202 and the output resonator 213, and coupling 231 between the input resonator 211 and the output resonator 213. However, the bandpass filter pattern shown in FIG. 2a has no coupling between the input port 201 and the input resonator 211 and no coupling between the output port 202 and the output resonator 213 because the input port 201 and the output port 202 respectively come into contact with the input resonator 211 and the output resonator 213.

When a signal is input through the input port 201, the input signal is electric-coupled at coupling 221 with the input port 201 and the triangular patch input resonator 211. The electric-coupled signal is transmitted to the triangular patch upper resonator 212 through the electric coupling 222. This signal is transmitted to the triangular patch output resonator 213 through the electric coupling 223. The signal transferred to the output resonator 213 selects a characteristic band to be transmitted as an output signal through the electric coupling of the output port 202 and the triangular patch output resonator 213.

In FIG. 2a, main coupling is electric coupling, and the triangular patch input resonator 211 and the triangular patch output resonator 213 are electric-coupled. Accordingly, an attenuation pole is formed on the high side of the passband, and the attenuation pole characteristic and frequency are controlled by cross coupling.

In FIG. 2b, main coupling is electric coupling, and the input resonator 211 and the output resonator 213 are magnetic-coupled. Thus, an attenuation pole is formed on the low side of the passband. The bandpass filter of FIG. 2 is suitable for a mobile communication system because it has high selectivity channeling and low insertion loss.

FIG. 3 shows a pattern of a bandpass filter including multilayer resonators, disclosed in U.S. Pat. No. 6,608,538. The bandpass filter 300 shown in FIG. 3 includes an input port 301, an output port 302, an input resonator L11, L12, and C2, an upper resonator L21, L22, and C2, and an output resonator L31, L32, and C3. Each of the three resonators is composed of an inductive portion and a capacitive portion. The inductive portion of the second resonator is folded such that the inductive portion of the first resonator is coupled to the inductive portion of the third resonator forming a trisection filtering structure. An attenuation pole is formed on the low side of the passband by cross coupling between the first and third resonators.

When a signal is input through the input port 301, the input signal is resonated through the input resonator L11, L12, and C1. The resonated signal is transmitted to the upper resonator L21, L22, and C2 through electric coupling and resonated. Then, the resonated signal is transferred to the output resonator L31, L32, and C3 through electric coupling and resonated. This resonated signal is output through the output port 302.

The main coupling of the bandpass filter is electric coupling, and the input resonator L11, L12, and C2 and the output resonator L31, L32, and C3 are magnetic-coupled. Accordingly, the attenuation pole exists on the low side of the passband, and the attenuation pole characteristic and frequency are controlled by cross coupling. The bandpass filter shown in FIG. 3 is suitable for microwave devices, and its size and weight can be reduced because it uses LC-coupled resonators formed on multiple layers.

FIG. 4 shows a pattern of a bandpass filter including LC-coupled resonators. The bandpass filter of FIG. 4 includes three LC-coupled resonators, a cross coupling gap, a cross coupling line or a mixed structure of the cross coupling gap and cross coupling line.

Specifically, the bandpass filter 400 of FIG. 4 includes an input port 401, an output port 402, an input resonator 411, an upper resonator 412, and an output resonator 413. The bandpass filter 400 further includes coupling 422 between the input resonator 411 and the upper resonator 412. A cross coupling gap 423 exists between the upper resonator 411 and the output resonator 413, and a cross coupling line 431 exists between the input resonator 411 and the output resonator 413. In addition, a cross coupling line 432 exists between the input resonator 411 and the output resonator 413, and a cross coupling gap and a cross coupling line 433 exist between the input resonator 411 and the output resonator 413.

When a microwave signal is input to the LC-coupled input resonator 401 through the input port 201, the input signal is transmitted to the LC-coupled upper resonator 412 according to electric coupling and is then output to the output port 402 through the LC-coupled output resonator 413. An attenuation pole is formed on each of high and low sides of a passband according to the cross coupling gap, cross coupling line, or mixture of cross coupling gap and line existing between the input resonator and the output resonator.

The main coupling of the bandpass filter of FIG. 4 is electric coupling, and cross coupling is magnetic coupling or electric coupling. This bandpass filter is suitable for microwave devices and its size and weight can be reduced because it uses the LC-coupled resonators.

However, as a millimeter-wave home network system is miniaturized, the size, weight, and cost of a passive element such as the bandpass filter are required to be reduced. In addition, low loss and high attenuation characteristics of the bandpass filter are increasingly needed.

### SUMMARY OF THE INVENTION

It is an advantage of the present invention to provide a microstrip cross-coupled bandpass filter with an asymmetric frequency characteristic, which can be miniaturized and fabricated by an optimized fabrication process at a low manufacturing cost, and provide low loss and high attenuation pole characteristics.

It is another advantage of the present invention to provide a bandpass filter that is designed unrestrictedly, has a simplified pattern such that it can be fabricated by an optimized process at a low manufacturing cost, and is suitable for an system on package (SOP) of a millimeter-wave home network system and module.

In one aspect of the present invention, a microstrip cross-coupled bandpass filter comprises: an input port through which a signal is input; an output port through which a select signal of a characteristic band is output; and a plurality of resonators including at least a first resonator that is electric-coupled with at least a part of the input port and a second resonator that is electric-coupled with at least a part of the output port. Magnetic coupling is formed according to a cross coupling gap corresponding to the distance between the first and second resonators.

The bandpass filter can further comprise a third resonator that is electric-coupled with at least a part of the first resonator and at least a part of the second resonator.

The cross coupling gap forming the magnetic coupling generates an attenuation pole on the high side of a passband.

The attenuation frequency of the attenuation pole can be varied with a variation in the distance of the cross coupling gap.

The plurality of resonators can be λ/2 transmission line resonators.

The bandpass filter can further includes a cross coupling line that is coupled to at least a part of the input port and at least a part of the output port in a mixed form of capacitive coupling and transmission line inductive coupling.

The cross coupling line can generate an attenuation pole on each of the high and low sides of the passband.

The attenuation frequency of the attenuation pole can be varied with the distance between the cross coupling line and the input port and the distance between the cross coupling line and the output port, the length of the cross coupling line, and the width of the cross coupling line.

In another aspect of the present invention, a microstrip cross coupling bandpass filter comprises: an input port through which a signal is input; an output port through which a select signal of a characteristic band is output; a plurality of resonators including at least a first resonator that is electric-coupled with at least a part of the input port and a second resonator that is electric-coupled with at least a part of the output port; and a cross coupling line that is coupled to at least a part of the input port and at least a part of the output port in a mixed form of capacitive coupling and transmission line inductive coupling, and that generates an attenuation pole on each of the high and low sides of a passband.

The attenuation frequency of the attenuation pole can be varied with the distance between the cross coupling line and the input port and the distance between the cross coupling line and the output port, and the length and width of the cross coupling line.

The bandpass filter can further include a third resonator that is electric-coupled with at least a part of the first resonator and at least a part of the second resonator.

Magnetic coupling is formed according to a cross coupling gap corresponding to the distance between the first and second resonators to generate an attenuation pole on the high side of the passband.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows patterns of a conventional microstrip cross-coupled bandpass filter that includes open-loop resonators, and has an asymmetric frequency characteristic;

FIG. 2 shows patterns of a conventional microstrip cross-coupled bandpass filter that includes triangular patch resonators, and has an asymmetric frequency characteristic;

FIG. 3 shows a pattern of a conventional microstrip cross-coupled bandpass filter that includes multi-layer resonators, and has an asymmetric frequency characteristic;

FIG. 4 shows a pattern of a conventional microstrip cross-coupled bandpass filter that includes LC resonators, and has an asymmetric frequency characteristic;

FIG. 5 shows a pattern of a microstrip cross-coupled bandpass filter that includes λ/2 transmission line resonators, and has an asymmetric frequency characteristic according to a first embodiment of the present invention;

FIG. 6 shows a pattern of a microstrip cross-coupled bandpass filter that includes λ/2 transmission line resonators, and has an asymmetric frequency characteristic according to a second embodiment of the present invention;

FIG. 7a is a Pi-type equivalent circuit diagram of a cross coupling gap;

FIG. 7b is a circuit diagram of an ideal J-inverter;

FIG. 7c is an equivalent circuit diagram of an ideal J-converter and transmission line;

FIG. 8a shows a converted circuit of the equivalent circuit of the cross coupling gap of FIG. 7c;

FIG. 8b is an equivalent circuit diagram of a cross coupling line;

FIG. 8c shows a converted circuit of the equivalent circuit of the cross coupling of FIG. 8b;

FIG. 8d is an equivalent circuit diagram of a microstrip cross coupling gap and line;

FIG. 9a is an equivalent circuit diagram of the bandpass filter according to the first embodiment of the present invention;

FIG. 9b is an equivalent circuit diagram of the bandpass filter according to the second embodiment of the present invention; and

FIGS. 10a through 10e are graphs showing response characteristics of the bandpass filters according to the present invention.

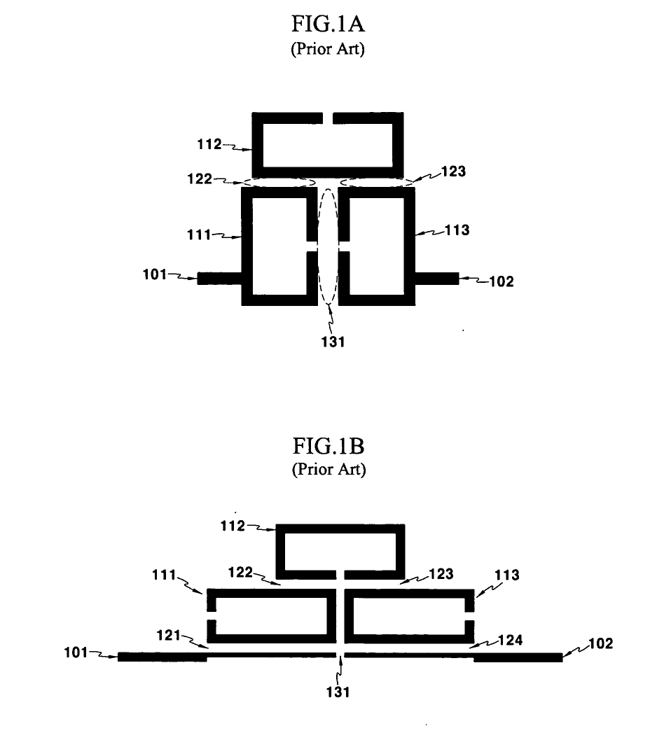

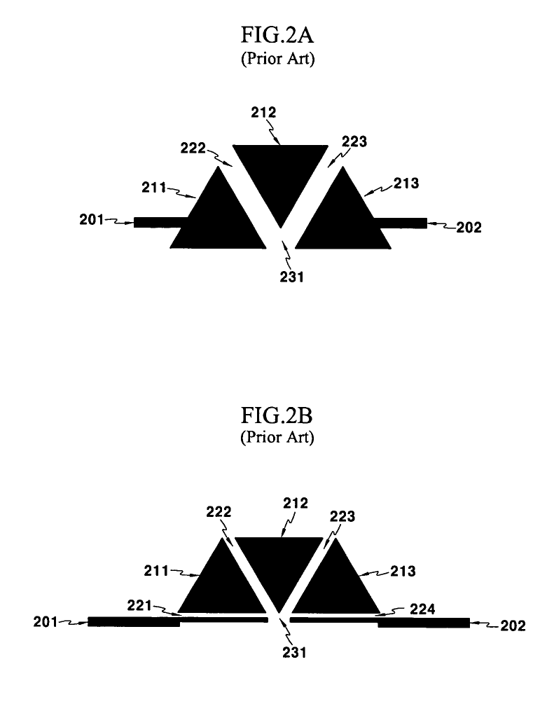

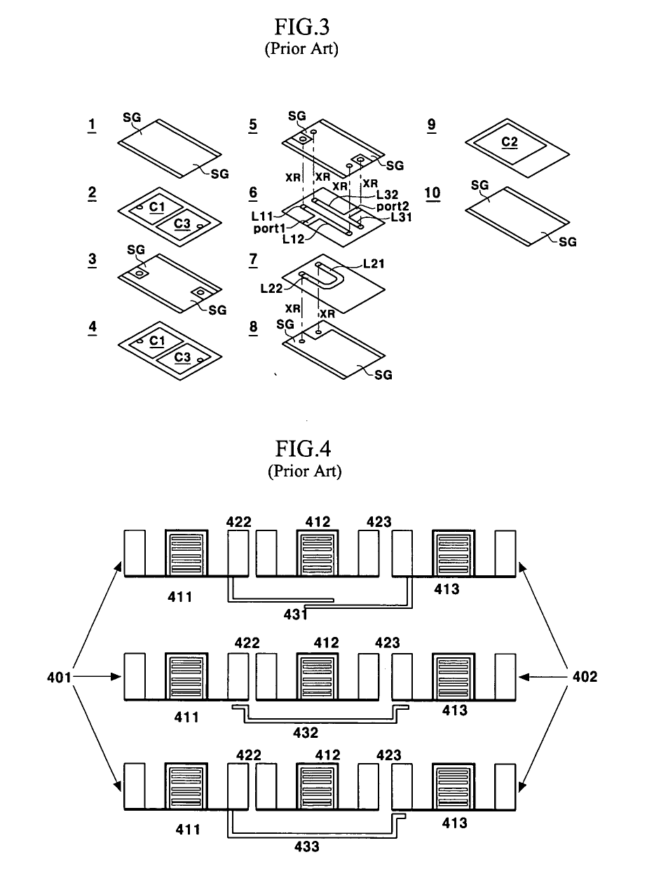

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which similar descriptions are provided have the same reference numerals.

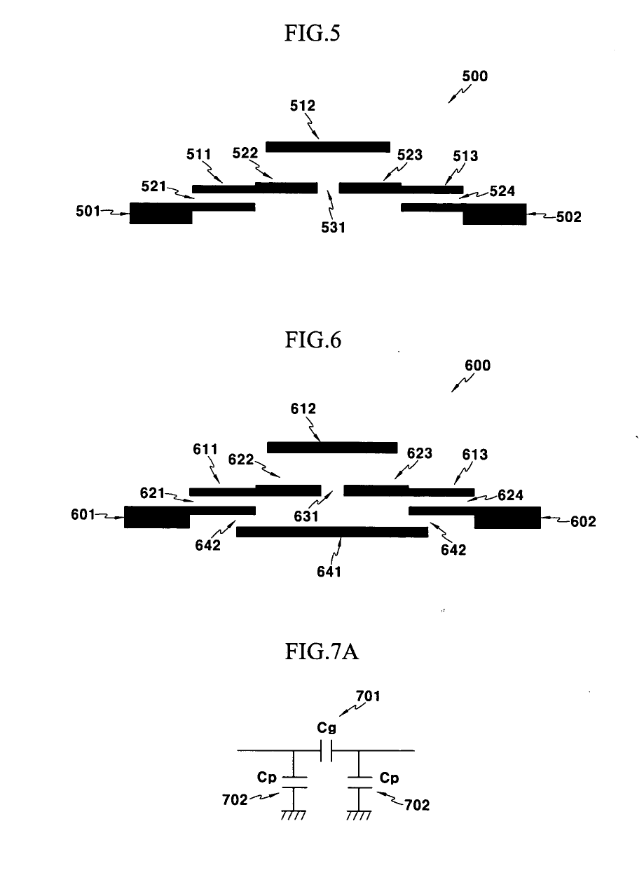

FIG. 5 shows a pattern of a microstrip cross-coupled bandpass filter that includes λ/2 transmission line resonators and has an asymmetric frequency characteristic according to a first embodiment of the present invention. The bandpass filter 500 according to the first embodiment of the present invention includes a cross coupling gap 531.

Specifically, the bandpass filter 500 is a parallel coupled filter and includes a λ/2 transmission line input resonator 511, a λ/2 transmission line upper resonator 512, a λ/2 transmission line output resonator 513, an input port 501, and an output port 502. In addition, the bandpass filter 500 further includes electric coupling 522 between the λ/2 transmission line input resonator 511 and the λ/2 transmission line upper resonator 512, electric coupling 523 between the λ/2 transmission line upper resonator 512 and the λ/2 transmission line output resonator 513, electric coupling 521 between the input port 501 and the λ/2 transmission line input resonator 511, and electric coupling 524 between the λ/2 transmission line output resonator 513 and the output port 502, and the cross coupling gap 531 has an attenuation pole characteristic.

When a microwave/millimeter-wave signal is input through the input port 501, the input signal is electric-coupled with the input port 501. Here, impedance is easily controlled irrespective of the degree of the dielectric constant because image impedance is used as the impedance.

The input electric coupling 521 is formed so that the microwave/millimeter-wave signal is transmitted to the λ/2 transmission line input resonator 511. Then, the microwave/millimeter-wave signal is transferred to the λ/2 transmission line upper resonator 512 by the electric coupling 522 between the λ/2 transmission line input resonator 511 and the λ/2 transmission line upper resonator 512.

Subsequently, the microwave/millimeter-wave signal is transferred to the λ/2 transmission line output resonator 513 through the electric coupling 523 between the λ/2 transmission line upper resonator 512 and the λ/2 transmission line output resonator 513. The microwave/millimeter-wave signal is filtered by the output electric coupling 524, and the filtered signal is output.

In the bandpass filter according to the first embodiment of the present invention, the ports and the resonators are mainly electric-coupled, and the λ/2 transmission line input resonator 511 and the λ/2 transmission line output resonator 513 are magnetic-coupled. Accordingly, an attenuation pole is formed on the high side of a passband, and an attenuation pole characteristic and frequency are controlled by the cross coupling gap 531.

FIG. 6 shows a pattern of a microstrip cross-coupled bandpass filter that includes λ/2 transmission line resonators and has asymmetric frequency characteristic according to a second embodiment of the present invention.

The bandpass filter 600 according to the second embodiment of the present invention is distinguished from the bandpass filter according to the first embodiment of the present invention in that the bandpass filter 600 has a cross coupling line 641 and coupling 642 of input/output ports and the cross coupling line 641. That is, the bandpass filter 600 includes the cross coupling gap and cross coupling line.

Specifically, the bandpass filter 600 includes λ/2 transmission line resonators that are parallel coupled filters 611, 612, and 613, an input port 601, an output port 602, electric coupling 621 between the input port 601 and the λ/2 transmission line input resonator 611, electric coupling 622 between the λ/2 transmission line input resonator 611 and the λ/2 transmission line upper resonator 612, electric coupling between the λ/2 transmission line upper resonator 612 and the λ/2 transmission line output resonator 613, electric coupling 624 between the λ/2 transmission line output resonator 613 and the output port 602, and a cross coupling gap 631 with an attenuation pole, and the cross coupling line 641 has another attenuation pole.

When a microwave/millimeter-wave signal is input through the input port 601, the input signal is electric-coupled with the input port 601. Here, impedance is easily controlled irrespective of the degree of dielectric constant because image impedance is used as the impedance.

The input electric coupling 621 is formed so that the microwave/millimeter-wave signal is transmitted to the λ/2 transmission line input resonator 611. Then, the microwave/millimeter-wave signal is transferred to the λ/2 transmission line upper resonator 612 by the electric coupling 622 between the λ/2 transmission line input resonator 611 and the λ/2 transmission line upper resonator 612.

Subsequently, the microwave/millimeter-wave signal is transferred to the λ/2 transmission line output resonator 613 through the electric coupling 623 between the λ/2 transmission line upper resonator 612 and the λ/2 transmission line output resonator 613. The transferred microwave/millimeter-wave signal is filtered by the output electric coupling 624 and the filtered signal is output.

In the bandpass filter 600 according to the second embodiment of the present invention, the ports and the resonators are mainly electric-coupled and the λ/2 transmission line input resonator 611 and the λ/2 transmission line output resonator 613 are magnetic-coupled. In addition, the input port 601 and the cross coupling line 641 are cross-coupled and the output port 602 and the cross coupling line 641 are also cross-coupled. The cross coupling 642 between the input port 601 and the cross coupling line 641 and between the output port 602 and the cross coupling line 641 has a mixed form of serial Pi-type capacitive coupling and transmission line inductive coupling.

Accordingly, an attenuation pole according to the cross coupling gap is formed on the high side of the passband, and an attenuation pole according to the cross coupling line is formed on each of the high and low sides of the passband. Therefore, an attenuation pole characteristic and frequency can be controlled by the cross coupling gap and cross coupling line.

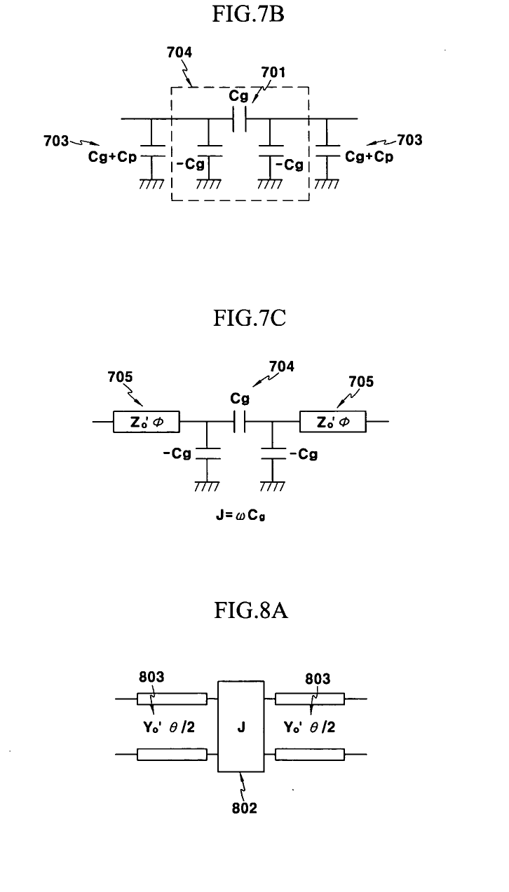

Equivalent circuits of the bandpass filters according to the first and second embodiments of the present invention will now be explained with reference to FIGS. 7, 8, and 9.

FIG. 7a is a Pi-type equivalent circuit diagram of the microstrip cross coupling gap 531 or 631 having an asymmetrical frequency characteristic, FIG. 7b is an equivalent circuit diagram of an ideal J-inverter changed from the cross coupling gaps 531 or 631 of FIG. 7a, and FIG. 7c is an equivalent circuit diagram of an ideal J-converter and transmission line changed from the J-converter of FIG. 7b.

In FIGS. 7a, 7b, and 7c, reference numeral 701 denotes the capacitance Cg of the cross coupling gap 531 or 631, 702 represents the capacitance Cp between the transmission line and ground, 703 denotes the sum of Cg+Cp, 704 indicates the J-inverter J=ωCg, and 705 represents the transmission line. Here, the J-inverter and susceptance are obtained by the following equations.

$$\begin{matrix}J = {Y}_{0} tan \vert \frac{ϕ}{2} \vert & [ Equation 1 ] \\ ϕ = - {tan}^{- 1} \frac{2 B}{{Y}_{0}} & [ Equation 2 ] \\ \vert \frac{B}{{Y}_{0}} \vert = \frac{\frac{J}{{Y}_{0}}}{1 - {( \frac{J}{{Y}_{0}} )}^{2}} & [ Equation 3 ]\end{matrix}$$

B=ωC_{g} [Equation 4]

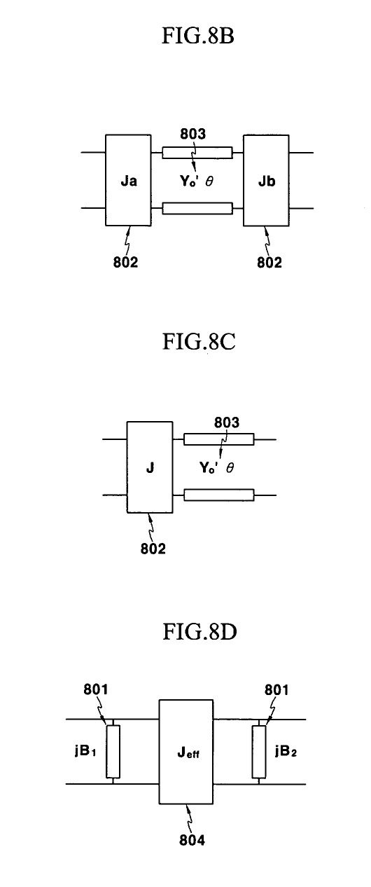

FIGS. 8a, 8b, 8c, and 8d are equivalent circuit diagrams of the microstrip cross coupling having an asymmetric frequency characteristic according to the present invention. FIG. 8a shows a converted circuit of the equivalent circuit of the cross coupling gap of FIG. 7c, and FIG. 8b is an equivalent circuit diagram of the microstrip cross coupling line 641 (shown in FIG. 6). FIG. 8c is an equivalent circuit diagram of the input coupling 521 or 621 and the output coupling 524 or 624, and FIG. 8d is an equivalent circuit diagram of the microstrip cross coupling.

FIG. 8a is obtained by Equations 1, 2, 3, and 4. Each of FIGS. 8a, 8b, and 8c can be converted to FIG. 8d. The J-inverter and susceptance are obtained by Equations 5 and 6 when FIG. 8a is converted to FIG. 8d, by Equations 7, 8, and 9 when FIG. 8b is converted to FIG. 8d, and by Equations 10, 11, and 12 when FIG. 8c is converted to FIG. 8d.

$$\begin{matrix}{J}_{eff} = \frac{1}{( \frac{- J {sin}^{2} \frac{θ}{2}}{{Y}_{0}^{2}} + \frac{{cos}^{2} \frac{θ}{2}}{J} )} & [ Equation 5 ] \\ B ( ω ) = \frac{sin \frac{θ}{2} cos \frac{θ}{2} ( \frac{J}{{Y}_{0}} + \frac{{Y}_{0}}{J} )}{( \frac{- J {sin}^{2} \frac{θ}{2}}{{Y}_{0}^{2}} + \frac{{cos}^{2} \frac{θ}{2}}{J} )} & [ Equation 6 ] \\ = {J}_{eff} ( sin \frac{θ}{2} cos \frac{θ}{2} ( \frac{J}{{Y}_{0}} + \frac{{Y}_{0}}{J} ) ) & \\ {J}_{eff} = \frac{{J}_{a} {J}_{b}}{{Y}_{0} sin θ} & [ Equation 7 ] \\ {B}_{1} ( ω ) = - {J}_{eff} ( \frac{{J}_{a}}{{J}_{b}} ) cos θ = - \frac{{J}_{a}^{2}}{{Y}_{0}} cos θ & [ Equation 8 ] \\ {B}_{2} ( ω ) = - {J}_{eff} ( \frac{{J}_{n}}{{J}_{a}} ) cos θ = - \frac{{J}_{b}^{2}}{{Y}_{0}} cos θ & [ Equation 9 ] \\ {J}_{eff} = \frac{J}{cos θ} & [ Equation 10 ] \\ {B}_{1} ( ω ) = - \frac{{J}^{2}}{{Y}_{0}} tan θ & [ Equation 11 ]\end{matrix}$$

B₂ (ω)=−Yₒ tan θ [Equation 12]

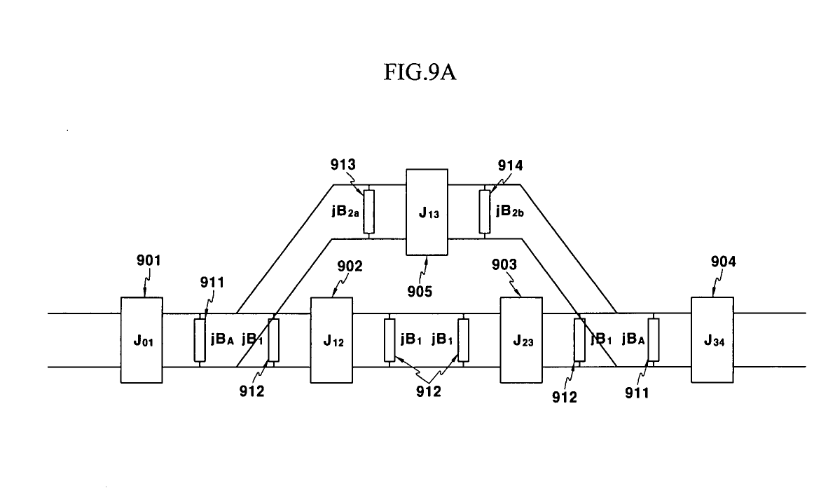

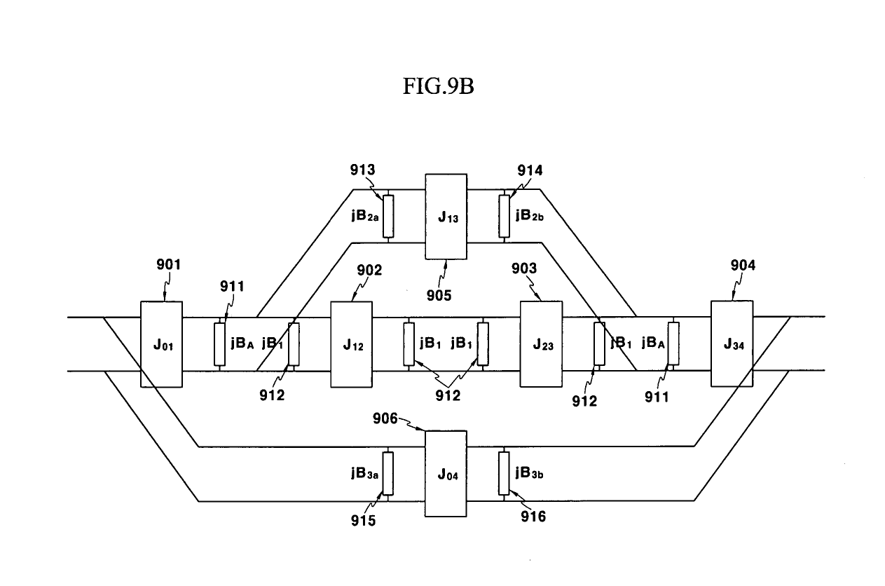

FIG. 9a is an equivalent circuit diagram of the bandpass filter 500 having the microstrip cross coupling gap, shown in FIG. 5, and FIG. 9b is an equivalent circuit diagram of the bandpass filter 600 having the microstrip cross coupling gap and microstrip cross coupling line, shown in FIG. 6.

In FIGS. 9a and 9b, reference numerals 901 through 906 denote inverters, 911 and 912 represent susceptance, 913 and 914 denote cross coupling gap susceptance, and 915 and 916 represent cross coupling line susceptance. In FIGS. 9a and 9b, the input admittance is represented by the following equation.

$${Y}_{ln} = {Y}_{1} \frac{{Y}_{0} + {jY}_{1} tan β l}{{Y}_{1} + {JY}_{0} tan β l} = {Y}_{1} \frac{{Y}_{1} - {jY}_{0} cot β l}{{Y}_{0} - {jY}_{1} cot β l} \\ = {Y}_{1} \frac{{Y}_{1} - {jY}_{0} cot ( \frac{π}{2} \frac{ω}{{ω}_{0}} )}{{Y}_{0} - {jY}_{1} cot ( \frac{π}{2} \frac{ω}{{ω}_{0}} )} \\ = {Y}_{1} \frac{{Y}_{1} + {jY}_{0} tan ( \frac{π}{2} ( \frac{ω - {ω}_{0}}{{ω}_{0}} ) )}{{Y}_{0} + {jY}_{1} tan ( \frac{π}{2} ( \frac{ω - {ω}_{0}}{{ω}_{0}} ) )} \\ = {Y}_{1} \frac{{Y}_{1} + {jY}_{0} tan ( \frac{π}{2} ( \frac{ω - {ω}_{0}}{{ω}_{0}} ) )}{{Y}_{0} + {jY}_{1} tan ( \frac{π}{2} ( \frac{ω - {ω}_{0}}{{ω}_{0}} ) )} \\ = {Y}_{1} \frac{\frac{{Y}_{1}}{{Y}_{0}} + j ( \frac{π}{2} ( \frac{ω - {ω}_{0}}{{ω}_{0}} ) )}{1 + j \frac{{Y}_{1}}{{Y}_{0}} ( \frac{π}{2} ( \frac{ω - {ω}_{0}}{{ω}_{0}} ) )} {\vert}_{ω = {ω}_{0}} \\ = \frac{{Y}_{1}^{2}}{{Y}_{0}} + {jY}_{1} X ( 1 - {A}^{2} ) \\ \text{In Equation 13,} \\ \frac{1}{j tan β l} = j cot β l , β l = \frac{2 π}{{λ}_{0}} θ = \frac{π}{2} , \\ X ( ω ) = \frac{π}{2} ( \frac{ω - {ω}_{0}}{{ω}_{0}} ) , and \\ cot ( \frac{π}{2} \frac{ω}{{ω}_{0}} ) = - tan ( \frac{π}{2} \frac{ω}{{ω}_{0}} - \frac{π}{2} ) \\ = - tan ( \frac{π}{2} ( \frac{ω - {ω}_{0}}{{ω}_{0}} ) ) . \qquad [ Equation 13 ]$$

In the meantime, the admittance Ya at the J₀₁ inverter 901 is obtained by the following equation.

$${Y}_{A} = \frac{{J}_{01}^{2}}{{Y}_{in}} = \frac{{J}_{01}^{2}}{\frac{{Y}_{1}^{2}}{{Y}_{0}} + {jY}_{1} X ( 1 - {A}^{2} )} \\ = \frac{{J}_{01}^{2}}{{Y}_{1} A + {jY}_{1} X ( 1 - {A}^{2} )} \\ = \frac{{J}_{01}^{2}}{{Y}_{1} A} [ 1 + jX ( A - \frac{1}{A} ) ] \\ = \frac{{J}_{01}^{2}}{{Y}_{1} A} + {jB}_{A} ( ω ) \qquad [ Equation 14 ]$$

In Equation 14, a λ/2 transmission line resonator jB_{A}(ω) can be represented by the following equation.

$${B}_{A} ( ω ) = \frac{{J}_{01}^{2}}{{Y}_{1} A} X ( ω ) ( A - \frac{1}{A} ) = \frac{{J}_{01}^{2}}{{Y}_{1}} X ( ω ) ( 1 - \frac{1}{{A}^{2}} ) \qquad [ Equation 15 ]$$

In FIG. 9a, the susceptance of the first λ/2 transmission line resonator 511 can be obtained by the following equation.
B₁(ω)=B_{A}(ω)+B(ω)+ω₀C_{g} [Equation 16]

In FIG. 9b, the susceptance of the first λ/2 transmission line resonator 611 can be obtained by the following equation.
B₁(ω)=B_{A}(ω)+B(ω)+ωC_{g}+B_{A}(ω) [Equation 17]

The input electric coupling 521 and 621 is formed through the aforementioned equations such that the microwave/millimeter-wave signal is transmitted to the λ/2 transmission line resonators 511 and 611.

The microwave/millimeter-wave signal is transmitted to the λ/2 transmission line upper resonator 512 or 612 through the electric coupling 522 622 between the λ/2 transmission line input resonator and the λ/2 transmission line upper resonator.

The λ/2 transmission line upper resonators 512 and 612 are formed by the following equation when the length of the transmission line is 20=π/2.

$${Z}_{in} = {Z}_{1} \frac{{Z}_{1} + {jZ}_{1} tan β l}{{Z}_{1} + {jZ}_{L} tan β l} \\ = {Z}_{1} \frac{{Z}_{L} + {jZ}_{1} π ( \frac{ω - {ω}_{0}}{{ω}_{0}} )}{{Z}_{1} + {jZ}_{L} π ( \frac{ω - {ω}_{0}}{{ω}_{0}} )} {\vert}_{ω = {ω}_{0}} \\ = {Z}_{1} \frac{1 + j \frac{{Z}_{1}}{{Z}_{L}} π ( \frac{ω - {ω}_{0}}{{ω}_{0}} )}{\frac{{Z}_{1}}{{Z}_{L}} + j π ( \frac{ω - {ω}_{0}}{{ω}_{0}} )} {\vert}_{ω = {ω}_{0}} \\ = \frac{{Z}_{1}}{j π ( \frac{ω - {ω}_{0}}{{ω}_{0}} )} {\vert}_{ω - {ω}_{0}} \\ = \frac{1}{{jY}_{1} π ( \frac{ω - {ω}_{0}}{{ω}_{0}} )} {\vert}_{ω = {ω}_{0} , {Z}_{L} 〉 〉 Z} \qquad [ Equation 18 ]$$

The susceptance of the λ/2 transmission line resonators 512 and 612 can be obtained by the following equation.

$$B ( ω ) = {Y}_{1} π ( \frac{ω - {ω}_{0}}{{ω}_{0}} ) = {Y}_{1} 2 X ( ω ) \qquad [ Equation 19 ]$$

The microwave/millimeter-wave signal is transmitted to the λ/2 transmission line output resonator 513 through the electric coupling 523 between the λ/2 transmission line upper resonator 512 and the λ/2 transmission line output resonator 513. The transmitted microwave/millimeter-wave signal is filtered by the output electric coupling 524 and output.

The mixed coupling 632 between the input port 601 and the cross coupling line 641 and between the output port 602 and the cross coupling line 641 can be obtained by Equations 5 and 6. Equations 5 and 6 can be attained from Equations 7, 8, and 9.

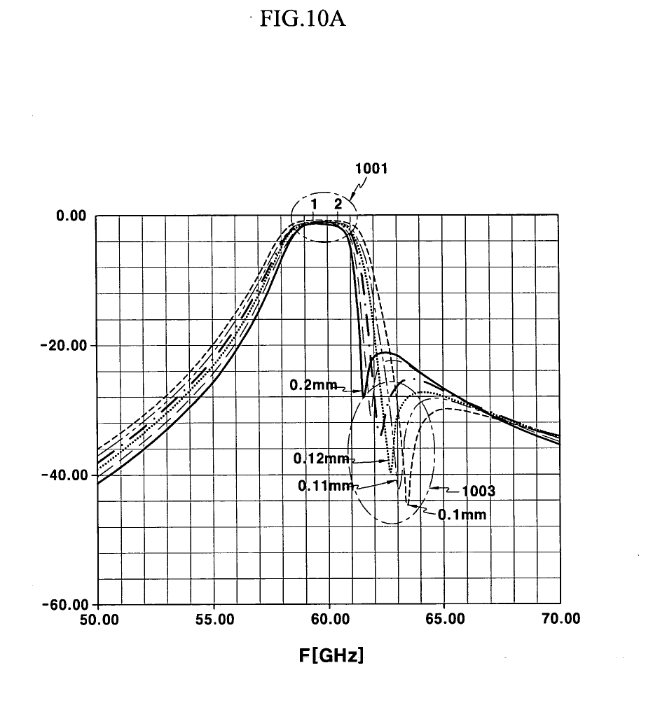

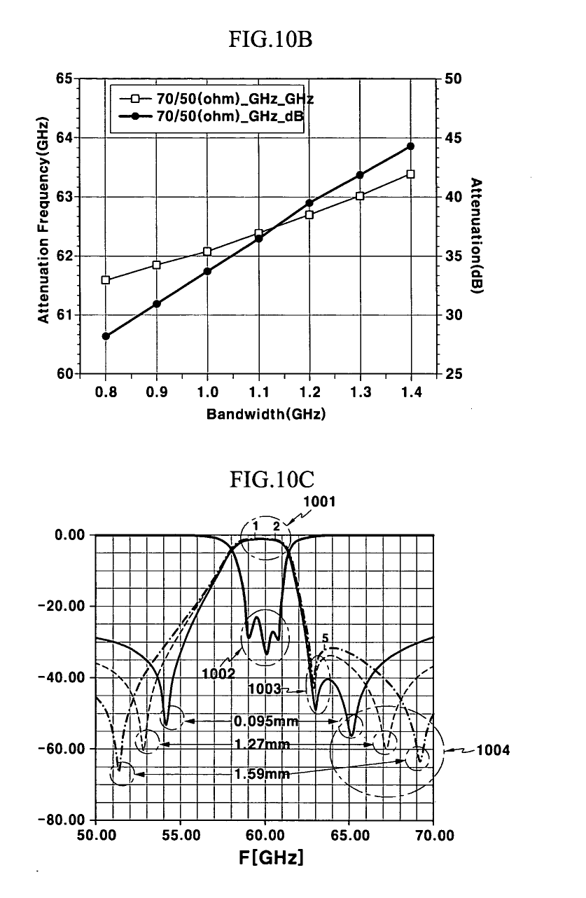

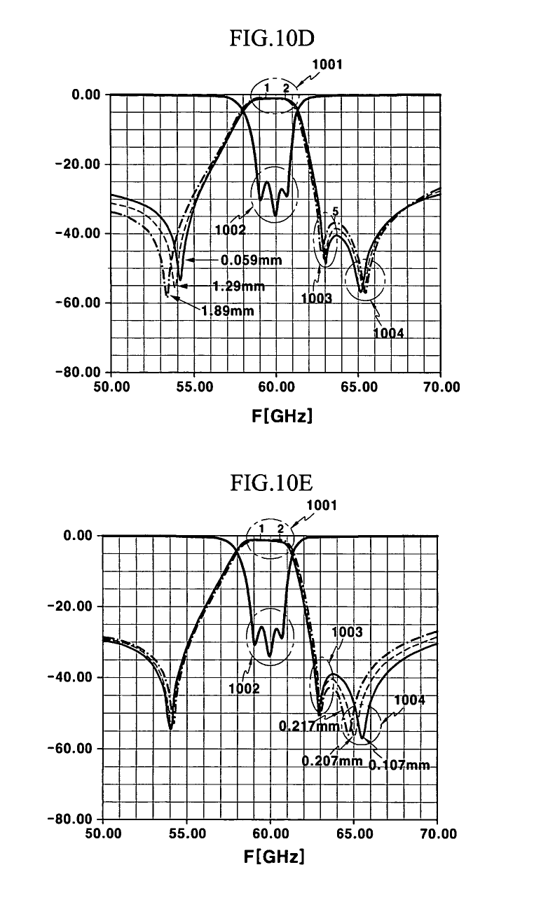

The response characteristic of the bandpass filter according to the present invention will now be explained with reference to FIGS. 10a through 10e. FIG. 10a shows the response characteristic of the bandpass filter 500 shown in FIG. 5 with respect to a variation in the microstrip cross coupling gap. That is, FIG. 10a is a graph showing the response characteristic of the bandpass filter having the cross coupling gap with a size of 0.1 through 0.2 mm.

Referring to FIG. 10a, there is no variation in a passband 1001 even when the distance of the gap is varied, and the attenuation frequency of an attenuation pole 1003 according to the cross coupling gap is increased as the distance of the gap is increased. Accordingly, the attenuation frequency can be controlled by the distance of the gap.

FIG. 10b shows the relationship between the bandwidth of the bandpass filter 500 having the microstrip cross coupling gap and the attenuation pole and attenuation frequency. FIG. 10c is a graph of the response characteristic of the bandpass filter 600 having the microstrip cross coupling gap and microstrip cross coupling line, which shows the relationship between the distance of the cross coupling gap and attenuation poles. Specifically, FIG. 10c shows the response characteristics when the distance of the cross coupling gap is 0.095 mm, 1.27 mm, and 1.59 mm. From FIG. 10c, it can be known that the attenuation pole 1003 is formed according to the cross coupling gap, and the upper and lower attenuation poles 1004 are formed according to the cross coupling line. Furthermore, as the distance of the cross coupling gap is increased, the attenuation frequency of the upper attenuation pole (right attenuation pole) 1004 is increased while the attenuation frequency of the lower attenuation pole (left attenuation pole) 1004 is decreased. Here, the attenuation pole 1003 according to the cross coupling gap is barely changed.

FIG. 10d is a graph of the response characteristic of the bandpass filter 600 having the microstrip cross coupling gap and microstrip cross coupling line, which shows the relationship between the width of the cross coupling line and attenuation poles. Specifically, FIG. 10d shows the response characteristics when the width of the cross coupling line is 0.059 mm, 1.29 mm, and 1.89 mm.

Referring to FIG. 10d, there is a small variation in the attenuation pole 1003 according to the cross coupling gap. Furthermore, the attenuation frequency of the lower attenuation pole 1002 is decreased as the width of the cross coupling line is increased. The attenuation frequency of the upper attenuation pole 1004 barely depends on a variation in the width of the cross coupling line. Accordingly, the lower attenuation pole can be changed by varying the width of the cross coupling line.

FIG. 10e is a graph of the response characteristic of the bandpass filter 600 having the microstrip cross coupling gap and cross coupling line, which shows the relationship between the length of the cross coupling line and attenuation poles. Specifically, FIG. 10e shows the response characteristics when the length of the cross coupling line is 0.217 mm, 0.207 mm and 0.107 mm.

Referring to FIG. 10e, the attenuation frequency of the upper attenuation pole is decreased as the length of the cross coupling line is increased. The attenuation frequency of the lower attenuation pole hardly depends on a variation in the length of the cross coupling line. Accordingly, the upper attenuation pole can be varied by changing the line of the cross coupling line.

As described above, the present invention can change the cross coupling gap and cross coupling line to vary the attenuation frequencies of the attenuation poles without changing the passband.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

The bandpass filters according to the present invention use resonators including a cross coupling gap or a cross coupling line. Thus, the size and weight of the microstrip cross coupling bandpass filter having an asymmetric frequency characteristic can be reduced. Furthermore, the pattern of the bandpass filter according to the present invention can be simplified so that the filter can be designed unrestrictedly. In addition, the filter fabrication process can be optimized to reduce the manufacturing cost.

Moreover, the present invention can change the attenuation frequency of an attenuation pole without changing a passband by varying the cross coupling gap and cross coupling line of the resonators. This provides low loss and a high attenuation pole.

Therefore, the bandpass filters according to the present invention are suitable for an SOP of a millimeter-wave home network system and module. Furthermore, the bandpass filters of the present invention can be easily used as RF filters for microwave mobile communication, personal communication, CT and satellite communication systems, and an image removal filter.

1. A microstrip cross-coupled bandpass filter comprising:
an input port through which a signal is input;
an output port through which a select signal of a characteristic band is output; and
a plurality of resonators including at least a first resonator that is electric-coupled with at least a part of the input port, and a second resonator that is electric-coupled with at least a part of the output port,
wherein magnetic coupling is formed according to a cross coupling gap corresponding to the distance between the first and second resonators.

2. The microstrip cross-coupled bandpass filter as claimed in claim 1, further comprising a third resonator that is electric-coupled with at least a part of the first resonator and at least a part of the second resonator.

3. The microstrip cross-coupled bandpass filter as claimed in claim 1, wherein the cross coupling gap forming the magnetic coupling generates an attenuation pole on the high side of a passband.

4. The microstrip cross-coupled bandpass filter as claimed in claim 3, wherein the attenuation frequency of the attenuation pole is varied with the distance of the cross coupling gap.

5. The microstrip cross-coupled bandpass filter as claimed in claim 1, wherein the plurality of resonators are λ/2 transmission line resonators.

6. The microstrip cross-coupled bandpass filter as claimed in claim 1, further comprising a cross coupling line that is coupled to at least a part of the input port and at least a part of the output port in a mixed form of capacitive coupling and transmission line inductive coupling.

7. The microstrip cross-coupled bandpass filter as claimed in claim 6, wherein the cross coupling line generates an attenuation pole on each of the high and low sides of the passband.

8. The microstrip cross-coupled bandpass filter as claimed in claim 7, wherein the attenuation frequency of the attenuation pole is varied with the distance between the cross coupling line and the input port and the distance between the cross coupling line and the output port.

9. The microstrip cross-coupled bandpass filter as claimed in claim 7, wherein the attenuation frequency of the attenuation pole is varied with the length of the cross coupling line.

10. The microstrip cross-coupled bandpass filter as claimed in claim 7, wherein the attenuation frequency of the attenuation pole is varied with the width of the cross coupling line.

11. A microstrip cross-coupled bandpass filter comprising:
an input port through which a signal is input;
an output port through which a select signal of a characteristic band is output;
a plurality of resonators including at least a first resonator that is electric-coupled with at least a part of the input port and a second resonator that is electric-coupled with at least a part of the output port; and
a cross coupling line that is coupled to at least a part of the input port and at least a part of the output port in a mixed form of capacitive coupling and transmission line inductive coupling and that generates an attenuation pole on each of the high and low sides of a passband.

12. The microstrip cross-coupled bandpass filter as claimed in claim 11, wherein the attenuation frequency of the attenuation pole is varied with the distance between the cross coupling line and the input port and the distance between the cross coupling line and the output port.

13. The microstrip cross-coupled bandpass filter as claimed in claim 11, wherein the attenuation frequency of the attenuation pole is varied with the length of the cross coupling line.

14. The microstrip cross-coupled bandpass filter as claimed in claim 11, wherein the attenuation frequency of the attenuation pole is varied with the width of the cross coupling line.

15. The microstrip cross-coupled bandpass filter as claimed in claim 11, further comprising a third resonator that is electric-coupled with at least a part of the first resonator and at least a part of the second resonator.

16. The microstrip cross-coupled bandpass filter as claimed in claim 15, wherein magnetic coupling is formed according to a cross coupling gap corresponding to the distance between the first and second resonators to generate an attenuation pole on the high side of the passband.
